(19) United States
(12) Patent Application Publication
(10) Pub. No.: US 2011/0159386 A1
(43) Pub. Date: Jun. 30, 2011

(54) OPERATING PROCESS FOR A FUEL CELL SYSTEM OPERATING PROCESS FOR A FUEL CELL

(76) Inventors: Andreas KAUPERT, Esslingen (DE); Jörg vom Schloß, Herzogenrath (DE)

(21) Appl. No.: 12/964,790

(22) Filed: Dec. 10, 2010

(30) Foreign Application Priority Data
Dec. 28, 2009 (DE) 10 2009 060 679.3

(51) Int. Cl. H01M 8/06

(52) U.S. Cl. 429/423

(57) ABSTRACT

A process for starting up a fuel cell system (1) is provided wherein the fuel cell system (1) has a fuel cell (2), a reformer (33) and an auxiliary burner (20). The fuel cell air is preheated with the auxiliary burner (20) and fed to a cathode side (8) of the fuel cell (2). Residual gas is circulated from an anode side (6) of the fuel cell (2) to the reformer (33) and from the reformer (33) to the anode side (6).

### CROSS REFERENCE TO RELATED APPLICATIONS

This application claims the benefit of priority under 35 U.S.C. §119 of German Patent Application DE 10 2009 060 679.3 filed Dec. 28, 2009, the entire contents of which are incorporated herein by reference.

### FIELD OF THE INVENTION

The present invention pertains to a process for operating a fuel cell system, especially for use in a motor vehicle or even for stationary applications, e.g., as an additional supply with current and heat, for example, in households or industrial areas.

### BACKGROUND OF THE INVENTION

A fuel cell system, which can be used as the only or an additional electric energy supply in a motor vehicle or in another mobile or stationary application, usually comprises a fuel cell, which is formed, as a rule, by a stack of individual fuel cell elements and which reacts an anode gas with a cathode gas for generating electric power or converters them into electric energy. A residual gas burner, which reacts the waste gases of the fuel cell, i.e., anode gas and cathode gas, while burner waste gas is formed, may be arranged downstream of the fuel cell. To generate a reformate gas, which can be fed to the fuel cell as an anode gas, the fuel cell system may be equipped, in addition, with a reformer. The fuel cell operates exothermally in the nominal operating state. The reformer likewise operates exothermally in the nominal operation when it operates with partial catalytic oxidation of the fuel.

Heat must be supplied for the fuel cell during a cold start of the fuel cell system, during which the power of the individual components is run up from the ambient temperature, in order for the fuel cell to reach its operating temperature. Heat must likewise be supplied to a reformer operating with a catalyst in order for the reformer to reach its operating temperature. The fuel cell system has a poor energy efficiency during this cold start operation. It likewise has comparatively high pollutant emission levels. To make it possible to carry out the start-up operation in as short a time as possible, it is possible to design the residual gas burner and the reformer especially for the start-up operation, such that the residual gas burner and the reformer generate the largest possible amount of heat during the cold start operation, which can then be utilized to heat up the components of the system. However, such a design for the cold start operation inevitably leads to incorrect design or overdimensioning for the nominal operating state. This leads especially to a worsening of the energy efficiency of the fuel cell system for the nominal operation.

### SUMMARY OF THE INVENTION

The present invention pertains to the object of providing for an operating process of such a fuel cell system an improved embodiment, which is characterized especially by a material-sparing and yet comparatively rapidly operating procedure and/or by increased efficiency of the fuel cell system.

According to the invention, a process is provided for starting up a fuel cell system. The fuel cell system has a fuel cell with a athode side and an anode side, a reformer and an auxiliary burner. Fuel cell air is preheated with the auxiliary burner and fed to the cathode side of the fuel cell. Residual gas is circulated from the anode side of the fuel cell to the reformer and from the reformer to the anode side.

The present invention is based on the general idea of additionally equipping the fuel cell system equipped with a reformer with an auxiliary burner, with which it is possible to preheat the air fed to the fuel cell during a cold start operation. The fuel cell air preheated with the auxiliary burner is then fed to a cathode side of the fuel cell. The fuel cell can as a result be heated to its operating temperature, as a result of which the heat-up phase becomes shorter. At the same time, the operating process according to the present invention provides for the cold start of the fuel cell system to circulate residual gas, which is contained in the gas-carrying component of the fuel cell system, from an anode side of the fuel cell to the reformer and from the reformer to the anode side, especially as long as the anode or anode side of the fuel cell is below an anode limit temperature. In other words, residual gas is circulated between the reformer and the anode side of the fuel cell in a section of the fuel cell system. Since the fuel cell air preheated by means of the auxiliary burner heats the cathode side of the fuel cell, this automatically also leads to heating of the anode side, so that heat transfer to the residual gas being circulated takes place as well. This circulating residual gas transports the heat to the reformer and brings about preheating of the reformer and especially of a catalyst of the reformer there.

The start procedure being presented here thus brings about at the same time a preheating of the fuel cell and of the reformer by means of the auxiliary burner. As a result, the reformer becomes ready for use more rapidly, which shortens the start-up procedure as a whole and a material-sparing procedure is embodied at the same time in order to make it possible to prevent damage to the individual components owing to excessive thermal load.

Due to the use of the auxiliary burner, it is possible to design, for example, a residual gas burner for a nominal operation of the fuel cell, because the auxiliary burner can be switched off at the end of the cold start operation. As a consequence, improved efficiency is obtained for the nominal operation of the fuel cell system.

According to an advantageous embodiment, the reformer can be operated at least temporarily in a reformer operating state before reaching a predetermined (first) anode limit temperature, which may be, for example, about 250° C. Such a reformer operation can be achieved at a sufficiently high temperature, for example, by temporarily feeding fuel and reformer air to the reformer at a corresponding air ratio. Oxygen contained in the residual gas, which continues to circulate, may possibly be reacted or consumed in this manner. It is important that the residual gas continue to circulate between the anode side and the reformer during this temporary operating state of the reformer. The total amount of oxygen gas contained in the residual gas can be reliably consumed in this manner. This temporary operating state of the reformer is carried out to make it possible to continue to circulate the residual gas even at rising temperatures, without the anode of the fuel cell becoming damaged. The risk of permanent damage to the anode by contact with oxygen increases significantly at higher temperatures, for example, beginning from 300° C.

Should a warm start of the reformer with immediate reformer operating state not be possible, cold start of the reformer must be carried out, during which it is operated at first in a burner operating state. According to a variant of the start procedure being presented here, the reformer can thus be operated in a burner operating state below a predetermined limit temperature of a catalyst of the reformer, wherein reformer air is fed to the reformer and reformer waste gas formed in the reformer is removed via a waste gas line. The reformer is then used as an additional heat source, namely, as an additional burner for heating the catalyst. As soon as the catalyst limit temperature is then reached, which may be between 350° C. and 900° C., the operation of the reformer can be changed over to the reformer operating state.

As long as the temperature on the anode side is below a reoxidation limit, which may be, for example, about 300° C., the gas arriving from the reformer can be sent through the anode side. The gas arriving from the reformer can be optionally sent to the waste gas line, bypassing the anode side, as a result of which the anode can be prevented from contacting the oxygen carried by the gas arriving from the reformer.

Regardless of whether the reformer waste gas flows through or bypasses the anode side, the reformer waste gas is used to preheat fuel cell air.

As soon as the catalyst of the reformer has reached a predetermined operating temperature, which is, for example, 900° C., the reformer can be operated especially effectively in its reformer operating state. The reformate gas usually contains no oxygen and can be sent through the anode side, which additionally leads to heating of the fuel cell. In addition, the reformate gas can be reacted in a residual gas burner together with the fuel cell air removed from the cathode side, i.e., burnt, as a result of which more heat is released, which can be used to preheat the fuel cell air.

The auxiliary burner can now be deactivated as soon as the residual gas burner takes over the preheating of the fuel cell air or as soon as a predetermined (second) anode limit temperature or anode operating temperature is reached.

Provisions may be made in another embodiment for switching off the reformer again when another (third) predetermined anode limit temperature is reached and for continuing to circulate the now-oxygen-free residual gas between the anode side and the reformer. This third anode limit temperature is markedly below the second anode limit temperature or below the anode operating temperature. However, the third anode limit temperature is also above the first anode limit temperature. There is a risk of soot formation or soot deposition on the anode of the fuel cell below the anode operating temperature, which may be, for example, 650° C. This risk can be considerably reduced by switching off the reformer, because the temperature range critical for soot formation is bypassed.

According to an advantageous variant, the reformer can again be switched on when another (fourth) predetermined anode limit temperature is reached and it can then be operated immediately in the reformer operating state. The fourth anode limit temperature is, at any rate, higher than the third anode limit temperature. The third anode limit temperature may be, e.g., about 350° C. The fourth anode limit temperature can be about 650° C. It can therefore be selected to be especially equal to the above-mentioned second anode limit temperature or the anode operating temperature. The repeated switching on of the reformer at the present, fourth anode limit temperature makes possible a warm start of the reformer, i.e., immediate operation of the reformer in the reformer operating state. The risk of soot formation or soot deposition on the anode is considerably reduced at the comparatively high temperatures now present.

As soon as the anode side or the fuel cell now reaches a minimum temperature, the fuel cell can be put into operation. The start procedure is then ended.

Corresponding to another advantageous embodiment, air can be introduced into the fuel cell air line downstream of the first heat exchanger to regulate a temperature of the fuel cell from a bypass air line, which bypasses a first heat exchanger arranged in a fuel cell air line, via a bypass line, which bypasses a second heat exchanger arranged in the bypass air line. The first heat exchanger can cooperate with the waste gas stream of the residual gas burner in order to heat the fuel cell air. The second heat exchanger can cooperate with the auxiliary burner in order to preheat the fuel cell air with the hot auxiliary burner waste gas. If it is necessary to reduce or limit a temperature of the fuel cell, e.g., the temperature of the electrolyte or a cathode temperature or an anode temperature, in order to prevent overheating of the fuel cell component in question, it is now possible to feed cooling air drawn in from the environment, bypassing both heat exchangers, to the fuel cell on the cathode side. This is made possible by means of the bypass line, which connects the bypass air line with the fuel cell air line between the two heat exchangers.

It is obvious that the above-mentioned features, which will also be explained below, are applicable not only in the particular combination indicated, but in other combinations or alone as well without going beyond the scope of the present invention.

Preferred exemplary embodiments of the present invention are shown in the drawings and will be explained in more detail below, identical reference numbers designating identical or similar or functionally identical components. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a highly simplified, circuit diagram-like general view of the fuel cell system;

FIG. 2 is a view as in FIG. 1, but for another operating state; and

FIG. 3 is a view as in FIGS. 1 and 2, but for another embodiment.

### DESCRIPTION OF THE PREFERRED EMBODIMENTS

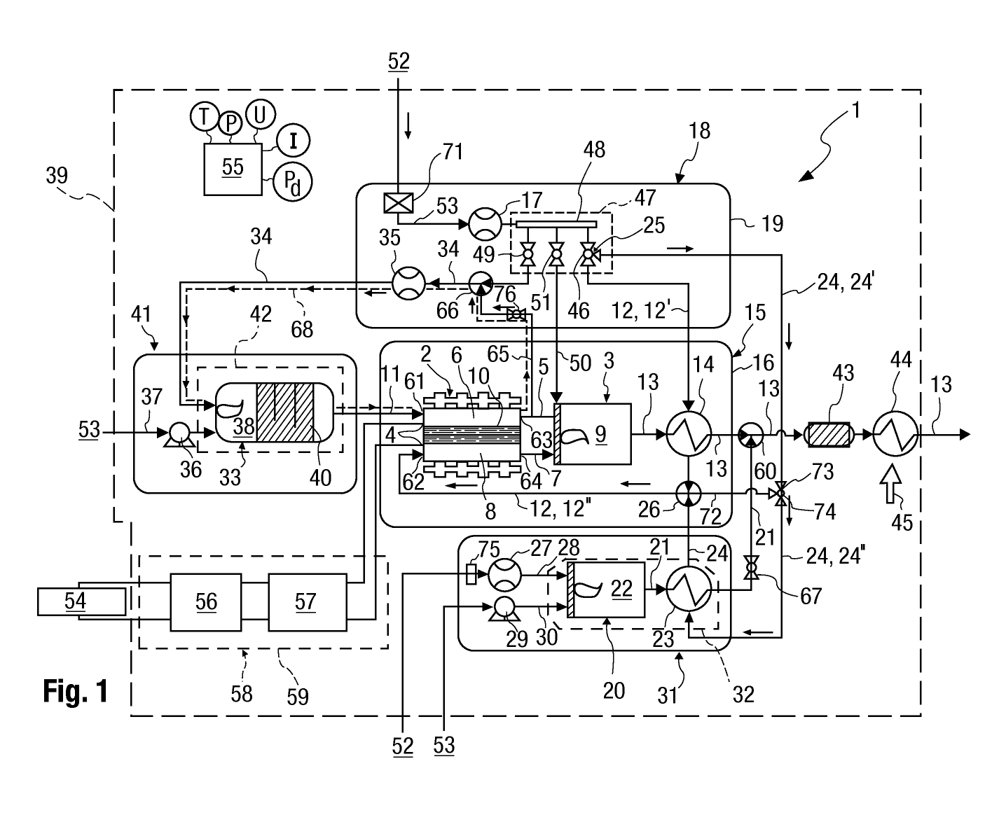

Referring to the drawings in particular, corresponding to FIGS. 1 through 3, a fuel cell system 1, which may be arranged in a motor vehicle or in any other mobile or stationary application as desired as the only or an additional electric energy source, comprises a fuel cell 2 and a residual gas burner 3. The fuel cell system 1 may also be used, as an alternative, for stationary applications. The fuel cell 2 generates electric current, which can be tapped via electrodes 4, from anode gas and cathode gas during the operation. The fuel cell 2 is preferably designed as an SOFC (Solid Oxide Fuel Cell). The residual gas burner 3 reacts anode waste gas with cathode waste gas during the operation while it produces burner waste gas. The reaction may take place with open flame. Catalytic reaction is also conceivable.

An anode waste gas line 5 connects an anode side 6 of the fuel cell 2 with the residual gas burner 3. A cathode waste gas line 7 connects a cathode side 8 of the fuel cell 2 with the residual gas burner 3. The reaction of the fuel cell waste gases will then take place in a combustion chamber 9 of the residual gas burner 3. The residual gas burner 3 may form a structurally integrated unit with the fuel cell 2. The anode waste gas line 5 and the cathode waste gas line 7 are internal lines or paths in this case.

An electrolyte 10 separates the anode side 6 from the cathode side 8 in the fuel cell 2. Anode gas is fed to the anode side 6 of the fuel cell 2 via a reformate gas line 11 or an anode gas line 11. Cathode gas is fed to the cathode side 8 of the fuel cell 2 via a fuel cell air line 12. The cathode gas is preferably air. A burner waste gas line 13 removes the burner waste gas generated by the residual gas burner 3 from the residual gas burner 3 or the combustion chamber 9 thereof. A first heat exchanger 14, which is integrated, in addition, in the fuel cell air line 12, is integrated in this burner waste gas line 13. The first heat exchanger 14 establishes a heat-transferring coupling between the fuel cell air line 12 and the burner waste gas line 13 in such a way that the media are separated from each other. The first heat exchanger 14 may be structurally integrated here in the residual gas burner 3.

The fuel cell system 1 is equipped in the example with a fuel cell module 15, which comprises the fuel cell 2, the residual gas burner 3 and the first heat exchanger 14. Furthermore, this fuel cell module 15 is equipped with a heat-insulating cover 16, which surrounds the components of the fuel cell module 15.

The fuel cell system 1 is equipped, moreover, with an air delivery means 17, which may be, e.g., a blower or a compressor or an electrically operated turbo-supercharger or a pump. This air delivery means 17 feeds air as a cathode gas during operation to the fuel cell 2 via the fuel cell air line 12. The air delivery means 17 is part of an air supply module 18, which has a heat-insulating and/or sound-insulating cover 19 of its own, in which the air delivery means 17 is arranged. The air delivery means 17 may be preferably equipped with a filter means 71 in order to filter out particles and/or aerosols from the air being delivered.

The fuel cell system 1 is equipped, in addition, with an auxiliary burner 20, which is configured such that it reacts air with a fuel into auxiliary burner waste gas during the operation. Said auxiliary burner waste gas is removed via an auxiliary burner waste gas line 21 or auxiliary waste gas line 21 for short from the auxiliary burner 20 or from a combustion chamber 22 of the auxiliary burner 20. The auxiliary waste gas line 21 preferably contains a shut-off member 67 for uncoupling the auxiliary burner 20 during normal operation of the fuel cell system 1, during which the auxiliary burner 20 is switched off. The shut-off member 67 now acts as a nonreturn lock. A second heat exchanger 23 is integrated in this auxiliary waste gas line 21. In addition, the second heat exchanger 23 is integrated in a bypass air line 24. The second heat exchanger 23 thus establishes a heat-transferring coupling between the auxiliary waste gas line 21 and the bypass air line 24 in such a way that the media are separated. The second heat exchanger 23 may be structurally integrated in the auxiliary burner 20.

The bypass air line 24 bypasses the first heat exchanger 14 on the air side. The bypass air line 24 is connected for this on the inlet side to the fuel cell air line 12 via a tapping point 25 between the air delivery means 17 and the first heat exchanger 14. The bypass air line 24 is connected on the outlet side to the fuel cell air line 12 via an introduction point 26 between the first heat exchanger 14 and the fuel cell 2. A first section of the fuel cell air line 12, which leads from the air delivery means 17 to the introduction point 26, will hereinafter be called 12′, whereas a second section of the fuel cell air line 12 leading from the introduction point 26 to the fuel cell 2 or to the cathode side 8 will hereinafter be designated by 12″.

Corresponding to the advantageous embodiments being shown here, a bypass line 72 may be optionally provided, which connects a tapping point 73 of the bypass air line 24 arranged upstream of the second heat exchanger 23 with the introduction point 26, i.e., with the fuel cell air feed line 12. This bypass line 72 makes it possible as a result to bypass the second heat exchanger 23 within the bypass air line 24. A first section of the bypass air line 24, which leads from the tapping point 25 to the other tapping point 73, will hereinafter be designated by 24′, whereas a second section of the bypass air line 24 leading from the other tapping point 73 to the introduction point 26 will hereinafter be designated by 24″. Another valve 74, which is preferably arranged in the example at the other tapping point 73, may be provided for controlling the bypass line 72.

Preheating of the fuel cell air takes place exclusively via the first heat exchanger 14 during normal operation of the fuel cell system 1, i.e., with the auxiliary burner 20 switched off. It may be necessary in certain operating situations to avoid a further temperature rise of the fuel cell 2 or to achieve cooling of the fuel cell. This may be necessary, for example, to protect a component of the fuel cell 2, e.g., the electrolyte 10, from overheating. The particular temperature of the fuel cell 2 can be regulated by cold ambient air, which is fed to the fuel cell air in order to reduce the temperature thereof. The cold ambient air may be fed via the bypass air line 24 to the second section 12″ of the fuel cell air line 12, while the bypass air line 24 bypasses the first heat exchanger 14. If, however, the auxiliary burner 20 is still active, e.g., during the start-up operation, the second heat exchanger 23 arranged in the bypass air line 24 must also be bypassed in order to make it possible to bring about cooling of the fuel cell air. The bypass line 72 is used for this. The cooling air then flows over the first section 24′ of the bypass air line 24 to the bypass line 72 and from the bypass line 72 into the second section 12′ of the fuel cell line 12. As a result, the cooling air bypasses, on the one hand, the first heat exchanger 14 and, on the other hand, the second heat exchanger 23.

The auxiliary burner 20 is supplied with air via an auxiliary air delivery means 27 and a corresponding air supply line 28. The auxiliary delivery means 27 may be preferably equipped with a filter means 75 in order to filter out particles and/or aerosols from the air being delivered. The air for the auxiliary burner 20 is preferably drawn in from an environment 52 of the fuel cell system. The auxiliary burner 20 is supplied with fuel by means of a fuel delivery means 29 via a corresponding fuel line 30. The fuel may be, e.g., any desired hydrocarbon. However, a fuel with which an internal combustion engine of the vehicle equipped with the fuel cell system 1 is also operated is preferred. Thus, the fuel is especially diesel fuel or biodiesel or heating oil. Gasoline or natural gas or any desired biofuel as well as synthetic hydrocarbons are also conceivable. Consequently, the fuel line 30 is preferably connected to a fuel tank 53 of the vehicle, which tank is not shown here in more detail.

The auxiliary burner 20 and the second heat exchanger 23 are parts of an auxiliary burner module 31 here, which has a heat-insulating cover 32 of its own here, in which the auxiliary burner 20 and the second heat exchanger 23 are arranged. In addition, the auxiliary air delivery means 27 and the fuel delivery means 29 of the auxiliary burner 20 are parts of the auxiliary burner module 31 in the example. However, these parts are arranged outside the corresponding cover 32.

The fuel cell system 1 is equipped, in addition, in the example being shown with a reformer 33, which reacts air with a fuel substoichiometrically, i.e., at an air ratio of <1 during the operation and generates hydrogen-containing and carbon monoxide-containing reformate gas. This reformate gas is fed as an anode gas via the reformate gas line 11 to the anode side 6 of the fuel cell 2. A reformer air line 34, which is likewise supplied by the air delivery means 17 here, is provided to supply the reformer 33 with reformer air. In addition, another delivery means 35, which will hereinafter be called reformer air delivery means 35, is arranged in the embodiment being shown in the reformer air line 34 downstream of the air delivery means 17. The air fed to the reformer 35 can be brought to an increased pressure level by means of this reformer air delivery means 35. In addition, this reformer air delivery means 35 may be designed as a hot gas delivery means. For example, it may be designed as a blower, compressor, electrically operated turbo-supercharger or a pump.

To supply the reformer 33 with fuel, a reformer fuel supply means 36 is provided, which feeds a suitable fuel to the reformer 33 via a corresponding fuel line 36. This may again be any desired hydrocarbon. The fuel that is also fed to the internal combustion engine of the vehicle equipped with the fuel cell system 1 is preferred.

The fuel line 37 provided for supplying the reformer 33 is correspondingly also preferably connected to the tank 53 of the vehicle.

Reformer 33 contains a combustion chamber 38 or mixing chamber 38. Reformer 33 contains, in addition, a catalyst 40, by means of which the reformate gas can be produced by means of partial oxidation.

Reformer 33 is part of a reformer module 41, which has a separate heat-insulating and/or gas-tight cover 42 or heat-insulating and/or gas-tight cover 42 of its own, in which the reformer 33 is arranged. The reformer fuel delivery means 36 belongs to the reformer module 41 in the example. However, said delivery means 36 is arranged for this outside the cover 42 of the reformer module 41.

The burner waste gas line 13 or waste gas line 13 for short contains an oxidation catalyst 43 for waste gas aftertreatment downstream of the first heat exchanger 14. In addition, a heating heat exchanger 44, which can heat up a fluid stream 45 indicated by an arrow during the operation, may be integrated in the waste gas line 13. This may be an air stream 45, which can feed the interior space of a vehicle, not shown. As an alternative, the fluid stream 45 may also be a coolant or a cooling circuit, wherein said cooling circuit contains a heat exchanger for heating an air stream, which can then be fed, e.g., to the interior space of a vehicle. The heating heat exchanger 44 is preferably arranged downstream of the oxidation catalyst 43. The heat possibly released in the oxidation catalyst 43 during the reaction of harmful substances can be used as a result to heat the interior space of the vehicle.

The tapping point 25, at which the bypass air line 24 branches off from the fuel cell air line 12, is advantageously designed as a valve or is arranged at a valve 46. This valve 46 makes it possible, e.g., to split the air stream being delivered by the air delivery means 17 as desired between the section of the fuel cell air line 12 led through the heat exchanger 14 and the bypass air line 24. Valve 46 is preferably part of a valve means 47, which splits the air being delivered on the pressure side by the air delivery means 17 via a distributor strip 48 between the fuel cell air line 12 and the reformer air line 34. Another valve 49, which may likewise belong to the valve means 47, may be provided for controlling the amount of air fed to the reformer 33. Furthermore, a cooling gas line or cooling air line 50, via which cooling air can be fed to the residual gas burner 3, is provided in the example. The cooling air line 50 can be controlled with a valve 51, which likewise belongs to the valve means 47 in the example. The air delivery means 17 likewise draws the air from the environment 52 of the fuel cell system 1 via a suction line 53. The valve means 47 is likewise part of the air supply module 18 in the example and is arranged within the corresponding cover 19.

The valves of valve means 47 and the air delivery means 17, 35 are preferably temperature-controlled or temperature-regulated. For example, valve 49, delivery means 17 and the reformer air delivery means 35 are regulated as a function of the temperature of the mixing chamber 38 and/or as a function of the temperature of the catalyst 40. Valve 51 and the air delivery means 17 may be regulated, e.g., as a function of the temperature of the combustion chamber 9. Valve 46 and the air delivery means 17 may be regulated, e.g., as a function of the temperature of the cathode side 8. Air delivery means 35 may be regulated, e.g., as a function of the temperature of the mixing chamber 38 and/or as a function of the temperature of the catalyst 40.

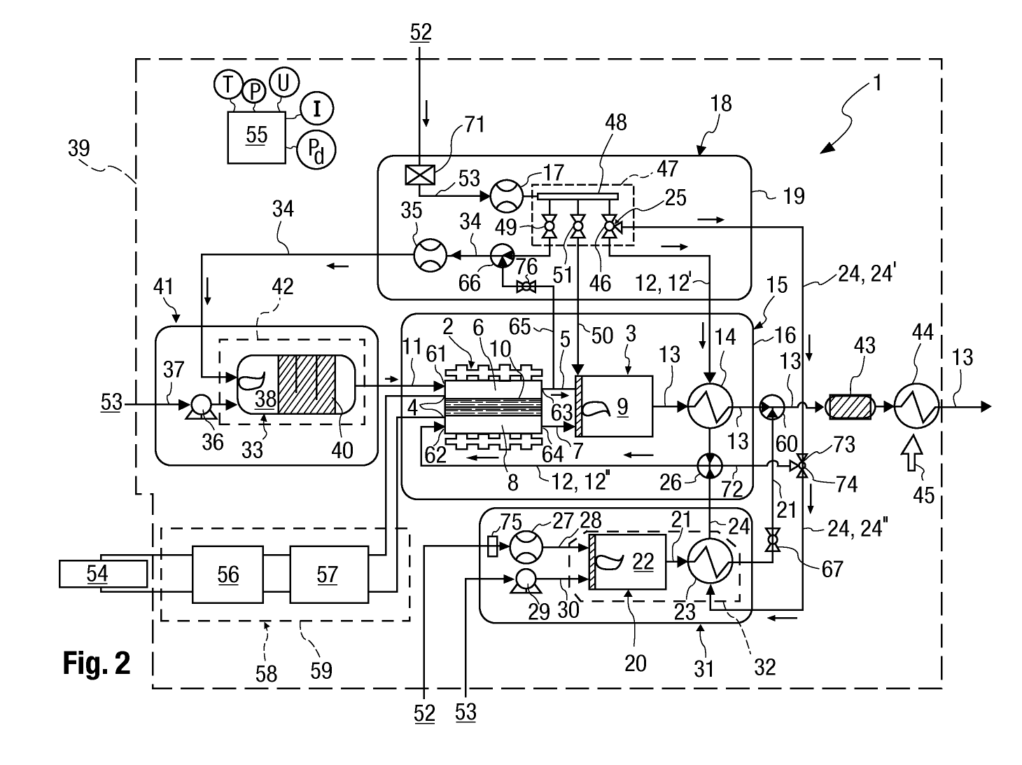

The electric current generated by means of the fuel cell system 1 is preferably used to supply electric consumers 54 with electric current or electricity. The one electric consumer 54 shown in FIGS. 1 and 2 symbolizes all the electric consumers that can be supplied with electricity by means of the fuel cell system 1. These are, on the one hand, external consumers, i.e., electric consumers 54 of the vehicle, e.g., an air conditioning system, a refrigerator, a coffee machine, a television set, etc. On the other hand, all internal consumers, i.e., all consumers 54 of the fuel cell system 1, are comprised as well. Electric consumers 54 of the fuel cell system 1 are, e.g., the delivery means 17, 27, 29, 35, 36, the valves 46, 49, 51, 67, 74, 76, as well as igniting means, e.g., glow plugs and spark plugs, with which a combustion reaction can be initiated in the residual gas burner 3, in the auxiliary burner 20 and in the reformer 33. A control means 55, by means of which the individual components of the fuel cell system 1 can be actuated, may also represent an electric consumer 54 of the fuel cell system 1.

Corresponding to the preferred embodiment being shown here, the fuel cell system 1 may, in addition, also have an electric energy storage means 56, which is designed, e.g., in the form of a battery. Capacitors are also conceivable as electric energy storage means 56. The energy storage means 56 is used to supply electric consumers of the fuel cell system 1. Furthermore, at least one voltage transformer 57, or transformer 57 for short, may be provided, by means of which a voltage transformation is carried out. For example, a DC/AC converter may be provided. In addition or as an alternative, a DC/AC converter may also be provided depending on the application. The transformer 57 in question transforms the voltage between a voltage level of the fuel cell 2, on the one hand, and a voltage level of the electric consumers 54 of the fuel cell system 1 and/or of the energy storage means 56, on the other hand. The energy storage means 56 and optionally also the transformer 57 may be accommodated in an energy storage module 58, which has, e.g., a housing 59 of its own. Housing 59 may also be designed, in particular, as a separate, heat-insulating and/or electromagnetically insulating cover, which may hereinafter also be called cover 59. An aforementioned DC/AC converter may be provided, especially in case of stationary applications, which may now be arranged, e.g., between the energy storage means 56 and the respective AC power consumer 54.

The auxiliary waste gas line 21 is connected to the waste gas line 13 via an introduction point 60 in the embodiments being shown here, namely, downstream of the first heat exchanger 14. This introduction point 60 is preferably positioned such that it is located upstream of the oxidation catalyst 43. As a result, the residual heat of the auxiliary burner waste gas can be used to heat the oxidation catalyst 43. At the same time, the residual heat of the auxiliary burner waste gas can be used to heat the heating heat exchanger 44.

The auxiliary waste gas line 21 is led in the embodiments shown in FIGS. 1 through 3 from the auxiliary burner 20 directly to the waste gas line 13. As an alternative, provisions may be made in another embodiment for the auxiliary waste gas line 21 to have a reformer branch, which is coupled with a housing of the reformer 33 in a heat-transferring manner. For example, this reformer housing may form a cover, through which a waste gas can flow, as a result of which reformer 33 is heated quasi from the outside. This branch of auxiliary waste gas line 21 branches off from the auxiliary waste gas line 21 advantageously via a valve, which makes it possible to split the auxiliary waste gas stream between the branch and the section of the auxiliary waste gas line 21 leading directly to the waste gas line 13 quasi as desired.

In addition or as an alternative, said branch may be coupled with an end plate of the fuel cell 2 in a heat-transferring manner. It is likewise possible to provide two branches in order to make it possible to heat the reformer 33 and the end plate of the fuel cell 2 with the auxiliary waste gas of the auxiliary burner 20 independently from one another.

Fuel cell 2 may typically have a stack-like structure, in which a plurality of plate-shaped fuel cell elements are stacked up on one another and thereby form a fuel cell stack or stack. The fuel cell stack is closed at its ends by two end plates, namely, by said end plate as well as by another end plate. This additional end plate has in the example an anode gas port 61, to which the anode gas line 11 or reformate gas line 11 is connected; a cathode gas inlet 62, to which the cathode gas line 12 or fuel cell air line 12 is connected; an anode waste gas outlet 63, to which the anode waste gas line 5 is connected, as well as a cathode waste gas outlet 64, to which the cathode waste gas line 7 is connected. Since all educt ports are thus arranged at this other end plate, this may also be called a port plate. Contrary to this, the other end plate forms only a closure of the fuel cell stack, so that it may also be called a closing plate.

In another embodiment, another cover, which is especially designed as a gas-tight cover, may be arranged in the heat-insulating cover 16 of the fuel cell module 15. This inner cover may likewise have a heat-insulating action. It is also conceivable to make the outer cover 16 gas-tight. Furthermore, one cover may be sufficient if it is designed as a heat-insulating and gas-tight cover. In particular, it is now possible to connect the aforementioned branch of the auxiliary waste gas line 21 to an interior space of the fuel cell module 15 enclosed by the inner cover. The branch opens now into said interior space at an introduction point and exits from the interior space at an outlet point located away therefrom. As a result, the fuel cell module 15 can be heated with the auxiliary burner waste gas. In particular, this may be combined with the heating of the fuel cell 2. For example, the auxiliary burner waste gas may be lead at first via the branch, not shown, to the closing plate and exit from this into the interior space in order to be removed again from the interior space via the outlet point.

The fuel cell system 1 is equipped, furthermore, in the preferred embodiments being shown here with a recirculation line, which is connected on the inlet side to the anode waste gas line 5 and on the outlet side via an introduction point 66 to the reformer air line 34, namely, upstream of the reformer air delivery means 35. Since the returned anode waste gas may have relatively high temperatures during the operation of the fuel cell system 1, the reformer air delivery means 35 is preferably designed for admission of hot gases, which gases may, in addition, also be toxic and/or explosive.

The valve means 47 is designed in the example to split air drawn in by the air delivery means 17 on the pressure side between the fuel cell air line 12, bypass air line 24, cooling air line 50 and reformer air line 34.

In another embodiment, not shown, the air delivery means 17 may be used, in addition, to supply the auxiliary burner 20 with air via the valve means 47. The auxiliary burner air line 28 may be connected for this to a distributor strip 48 via another valve. As an alternative, the auxiliary air delivery means 27 in the auxiliary burner air line 28 may also be eliminated.

The control means 55 is advantageously designed or programmed such that it can carry out the following operating state. It may be connected for this to a sensor system, not designated more specifically, which may have a plurality of sensors for temperatures T, pressures p, voltages U, currents I and electric power Pₑₗ.

The auxiliary burner waste gas is used to preheat the fuel cell air, which is led for this through the bypass air line 24, during a start-up operation of the fuel cell system 1, especially during a cold start. At the same time, the auxiliary burner waste gas can be used to preheat the oxidation catalyst 43 during the start-up operation. The auxiliary burner waste gas can be additionally used to preheat the reformer 33 in the embodiment described farther above. As an alternative or in addition, the auxiliary burner waste gas may also be used to preheat the end plate of the fuel cell 2 according to the above-described embodiment. As an alternative or in addition, the auxiliary burner waste gas may also be used to preheat the entire fuel cell module 15 according to the other above-described embodiment. As soon as the start-up operation has been terminated, the auxiliary burner 20 can be switched off. In particular, the auxiliary burner 20 is switched off during a nominal operation of the fuel cell system 1.

In addition to the preheating of the fuel cell air by means of the auxiliary burner 20, residual gas circulation may be embodied in a circulation circuit 68, which is indicated by an uninterrupted line in FIG. 1, during a cold start of the fuel cell system 1, during which especially the reformer 33 has ambient temperature as well. Residual gas is circulated in this circulation circuit 68 from the anode side 6 to the reformer 33 and from the reformer 33 to the anode side 6. The delivery means 35 is activated for this, while valve 49 is closed at the same time in order to avoid drawing in air from the environment 52. Consequently, the delivery means 35 removes residual gas from the recirculation line 65 and thus from the anode side 6 via the anode waste gas line 5. On the pressure side, the delivery means 35 delivers this residual gas via the reformer air line 34 to the reformer 33. This residual gas then reaches again the anode side 6 of the fuel cell 2 from the reformer 33 via the reformate gas line 11.

Another valve 76, preferably one designed as a hot gas valve, which is arranged in the recirculation line 65 between the introduction point 66 and the anode waste gas line 5, may be provided for regulating the residual gas circulation. This additional valve 76 is advantageously located within cover 19, so that it forms part of the air supply module 18.

The term “residual gas” designates in this connection the gas that is contained within the circulation circuit 68, i.e., within the components and line sections affected thereby. These are especially residues of air and anode gas residues or reformate gas residues.

During this start procedure, the air delivery means 17 delivers fuel cell air via the correspondingly switched valve 46 from the tapping point 25 via the bypass air line 24 through the second heat exchanger 23 to the introduction point 26 and from there via the second section 12″ of the fuel cell air line 12 to the cathode side 8 of the fuel cell 2. The fuel cell air then flows farther via the cathode waste gas line 7 through the first residual gas burner 3 and via the burner waste gas line 13 through the first heat exchanger 14. The fuel cell air heated up in the second heat exchanger 23 can now release a relatively large amount of heat to the cathode, i.e., to the electrolyte 10. At the same time, the anode is also heated up hereby by heat transfer, so that the circulating residual gas sent through the anode side 6 can take up heat and send it to the reformer 33. Reformer 33 can likewise be heated up in this manner. In particular, catalyst 40 of the reformer 33 can be preheated in this manner.

Depending on predetermined boundary conditions, reformer 33 can now be operated at least temporarily as a burner. For example, the anode side 6 shall be prevented from coming into contact with oxygen above a predetermined, first anode limit temperature. Reformer 33 is correspondingly changed over at least temporarily into a reformer operating state before this predetermined, first anode limit temperature is reached, which may be, for example, about 250° C. Oxygen that may possibly be present in the residual gas is consumed during this reformer operation. The circulation circuit 68 remains preserved during this reformer operation of reformer 33, so that oxygen, which is still contained in the residual gas, is consumed in this reformer operating state. As soon as no more oxygen is present in the circulating residual gas, reformer 33 can again be switched off, while the circulation operation continues. Temperatures above the first anode limit temperature can also now be used without there being a risk of damage to the electrolyte 10 by oxygen in the residual gas on the anode side.

It is also possible as an alternative to continue to operate the reformer 33 in the reformer operating state in order to use it as an additional heat source for heating the fuel cell 2. However, the risk of soot formation and soot deposition on the anode side 6 of the fuel cell 2 increases now, because the temperatures are, on the whole, still relatively low at least at the anode or on the anode side 6 of the electrolyte 10. To avoid such a soot deposition, it may therefore be advantageous, as was described above, to temporarily switch off the reformer 33 in order to heat up the fuel cell 2 further via the auxiliary burner 20 to the extent that the temperature range critical for soot deposition is exceeded.

To make it possible to operate the reformer 33 in the reformer operating state, its catalyst 40 must have a predetermined catalyst limit temperature, which is at least 350° C. and may maximally reach about 900° C. If the catalyst temperature is above this catalyst limit temperature, warm start of the reformer 33 is possible, i.e., the reformer 33 can be immediately operated in its reformer operating state. However, if the catalyst temperature is below this catalyst limit temperature, cold start must be carried out for the reformer 33. In case of a cold start of the reformer 33, it operates at first in a burner operating state until its catalyst reaches the catalyst limit temperature. The operation of the reformer 33 can then be changed over into the reformer operating state. Reformer 33 is supplied with reformer air and fuel at a highly superstoichiometric ratio for the reformer operating state. The supply of media for the reformer 33, i.e., the feed of reformer air and fuel, can be briefly interrupted for the changeover from the burner operating state to the reformer operating state.

As soon as reformer 33 is operated in the burner operating state or in the reformer operating state, reformer air is also fed by correspondingly actuating valve 49. At the same time, gas arriving from the reformer via the anode waste gas line 5, i.e., reformer waste gas or reformate gas, is sent to the residual gas burner 3, so that a combustion reaction can be carried out there by means of the cathode air. Burner waste gas formed in the process can be used in the first heat exchanger 14 to heat cathode air, which is then sent via the cathode gas line 12. It is possible now, in particular, to heat up the air intended for the cathode side 8 both via the cathode air line 12 and via the bypass air line 24.

The state according to FIG. 2 becomes established in this case. The hot reformate gas is now sent via the reformate line 11 to the anode side 6, where the hot reformate gas can release heat to the fuel cell 2. the reformate gas is then sent farther via the anode waste gas line 5 through the residual gas burner 3 and via the burner waste gas line 13 farther through the first heat exchanger 14. Beginning from this point in time, heat can also be transmitted to the fuel cell air via the first heat exchanger 14 in order to heat this fuel cell air. A partial stream of the fuel cell air can also be correspondingly sent via the first section 12′ of the fuel cell air line 12 by correspondingly actuating valve 46. In proportion to this, the output of the auxiliary burner 20 or the air stream through the bypass line 24 can be reduced.

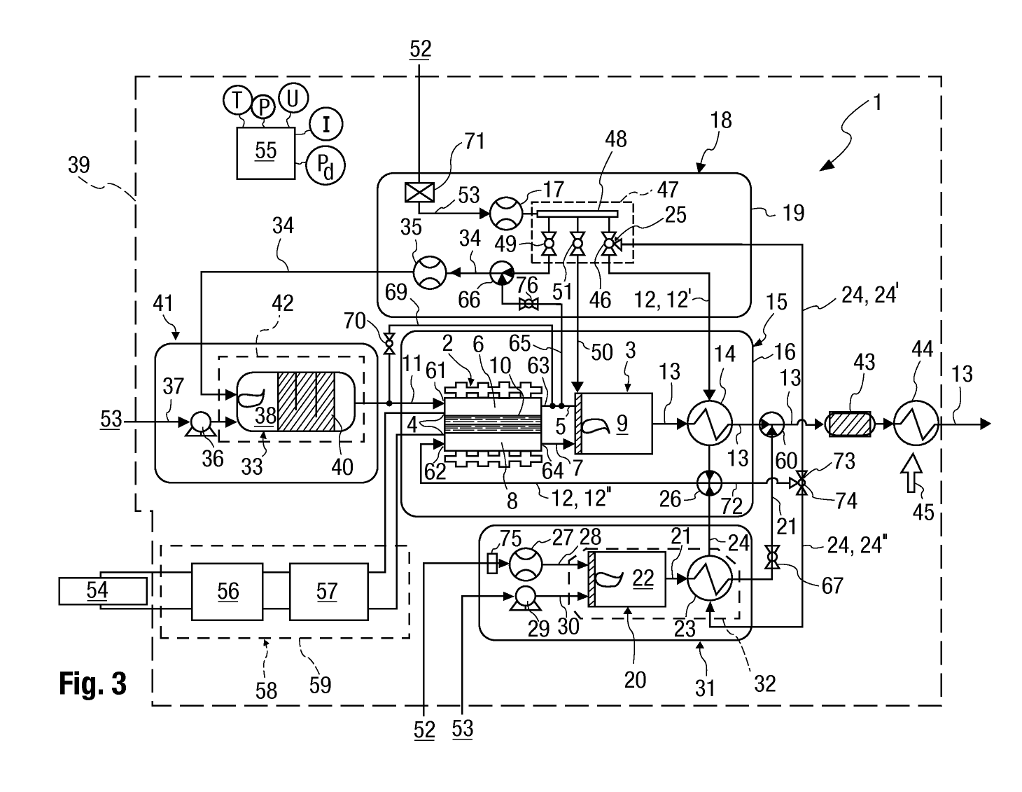

FIG. 3 shows an alternative embodiment, in which an additional bypass line 69 is provided, which branches off from the reformate gas line 11 and bypasses the anode side 6 of the fuel cell 2. It is possible as a result to carry out the burner operating state even over a longer period of time, for example, in order to heat up the reformer 33 in a material-sparing manner, without there being a risk of damage to the anode due to residual oxygen. This bypass line 69 is connected in the example to the anode waste gas line 5, so that reformer waste gas is again introduced into the original path upstream of the residual gas burner 3. The bypass line 69 can be controlled with a corresponding valve 70. The bypass line 69 is advantageously designed for this purpose such that its flow resistance is lower than the flow resistance of the anode side 6 of the fuel cell 2. With valve 70 open, the reformer waste gas, following the path of least resistance, will not then flow through the anode side 6 but through the bypass line 69. The reformer 33 can be operated in this variant in its burner operating state superstoichiometrically without any problem, because the anode side 6 is not expected to come into contact with residual oxygen in the reformer waste gas. This superstoichiometric mode of operation of the reformer 33 quasi as desired simplifies the burner operation of the reformer 33, especially to maintain lower temperatures.

As soon as a catalyst operating temperature or activation temperature of the catalyst 40 is reached, the mode of operation of the reformer 33 can be changed over from the burner operating state to a reformer operating state. This can be achieved, for example, by reducing the supply of the reformer 33 with reformer air and/or increasing the supply with fuel in order to change over from a superstoichiometric operating state into a substoichiometric one, in which only partial oxidation, by means of which the desired reformate gas can be produced, is possible in the catalyst 40. The reformate gas does not usually contain any oxygen during this reformer operating state, so that it is possible again to send the reformate gas through the anode side 6 in order to heat the fuel cell 2 further. A relatively large amount of thermal energy is stored chemically in the reformate gas, namely, in the form of highly reactive hydrogen and carbon monoxide. A reaction of the reformate gas with the cathode air, which is likewise removed from the cathode side 8 through the residual gas burner 3, can now be carried out in the residual gas burner 3. As a consequence, very hot burner waste gas can be generated, which is removed via the burner waste gas line 13. Intensive heat transfer to the fuel cell air can now be carried out in the first heat exchanger 14. As a consequence, the fuel cell air can be preheated via the waste heat of the burner waste gas.

As soon as the residual gas burner 3 is activated in order to completely take over the preheating of the fuel cell air, the auxiliary burner 3 is not needed any longer, so that it can be deactivated. As an alternative, the auxiliary burner 20 can also be deactivated only when the fuel cell 2 has reached its minimum operating temperature. However, since the residual gas burner 3 can generate a very large amount of heat, sufficient heating of the fuel cell 2 can be achieved basically exclusively via the fuel cell air line 12, so that the bypass air line 24 can be deactivated.

To prevent a temperature shock at the second heat exchanger 23 when the auxiliary burner 20 is switched off, it may be advantageous to activate the bypass line 72 for the switch-off operation, so that the fuel cell air flows from the tapping point 25 via the first section 24′ of the bypass air line 24 to the farther tapping point 73, after which it reaches the introduction point 26 through the bypass line 72 and then reaches the cathode side 18 via the second section 12′ of the fuel cell air line 12. The second section 24″ of the bypass air line 24 is then deactivated, so that no cold ambient air is then admitted any longer to the second heat exchanger 23. The auxiliary burner 20 can be switched off in a material-sparing manner as a result.

The residual gas burner 3 is operated specifically such that its burner waste gas does not exceed a predetermined heat exchanger limit temperature. This heat exchanger limit temperature must be maintained for the first heat exchanger 14 arranged in the burner waste gas line 13 in order to prevent this first heat exchanger 14 from being overheated.

If the bypass line 69 for bypassing the anode side 6 is present, as in the embodiment shown in FIG. 3, it may be advantageous to bypass the anode side 6 for the reformer operation of the reformer 33 as well. For example, it may be advantageous for a phase of the start-up procedure, during which the fuel cell 2 is relatively cold compared to the reformate gas, to bypass the fuel cell 2 in order to prevent a thermal shock of the electrolyte 10 due to the admission of the very hot reformate gas.

The heating of the electrolyte 10 will then continue via the preheated fuel cell air, i.e., via the cathode side 8. As soon as the temperature difference has reached an acceptable value, the hot reformate gas can then be sent through the anode side 6 in order to bring about the rest of the heating of the fuel cell 2. It can then be activated as soon as the fuel cell 2 has reached its electrolyte operating temperature.

If the fuel cell system 1 is started when the reformer 33 is still warm, i.e., its catalyst 40 has its minimum temperature or its activation temperature, it is also possible to jump over the circulation operation shown in FIG. 1, in which the circulation circuit 68 is embodied, in order to start the reformer 33 in the burner operating state or immediately in the reformer operating state if its catalyst 40 has a sufficient temperature.

As was explained, the reformer 33 can be started as a burner during the start-up operation, which can be achieved especially by superstoichiometric supply of air. After reaching the activation temperature of the catalyst 40 of the reformer 33, it is then possible to change over from the burner operation to the reformer operation. The air ratio is set for this purpose to a suitable substoichiometric value. The reformer 33 begins during the start-up operation of the fuel cell system 1 with a comparatively low reformer output, which corresponds, e.g., to about one third of the reformer output seen during nominal operation. The air ratio in the reformer is still comparatively high now at the beginning in order to keep the percentages of carbon monoxide and residual hydrocarbons in the reformate gas low. As soon as the fuel cell temperature has reached a minimum operating temperature, the reformer output is gradually increased, and the air ratio is reduced at the same time in order to increase the percentages of hydrogen and carbon monoxide in the reformate gas.

Reformer 33 may be designed as a self-starting reformer 33, for which it is equipped especially with a suitable igniting member, not shown here. It can be operated as a burner in order to reach the activation temperature of its catalyst 40. A reformate gas with a high percentage of hydrogen and high percentage of carbon monoxide can be generated in the reformer operation in the reformer 33 or at the catalyst 40 thereof by a substoichiometric fuel-to-air ratio.

With the auxiliary burner 20 switched off, the bypass air line 24 can be useful for regulating the temperature of the fuel cell 2. Since the bypass air line 24 bypasses the first heat exchanger 14, the air being transported therein is relatively cold, at least relative to the air sent through the first heat exchanger 14. This makes it possible to set a defined air temperature for the cathode side 8 of the fuel cell 2 for regulation purposes.

The auxiliary burner 20 can be used, e.g., to carry out a parking heater operation, especially with the fuel cell system 1 switched off. The hot auxiliary waste gases generated by means of the auxiliary burner 20 heat the heating heat exchanger 44 and make it possible as a result to heat the air stream 45.

The energy storage means 56 may be used, on the one hand, to operate the electric consumers 54 of the fuel cell system 1, especially the various delivery means for supplying media, igniting members, heating elements and the control device 55. This may be necessary, e.g., for the start-up operation, as long as the fuel cell 2 itself does not generate any electric current. On the other hand, electric energy generated by the fuel cell system 1 can be fed into the energy storage means 56. For example, the energy storage means 56 can be charged as a result in a simple manner. Should the dynamics of the external electric consumers, e.g., an electrically operated compressor of an air conditioning system, have a faster characteristic than the dynamics of the fuel cell system 1, the energy storage means 56 can also act, in addition, as a buffer system. This buffer system could supply, on the one hand, the additional electric energy needed for the particular external consumer 54. On the other hand, the buffer system could take up excess electric energy of the fuel cell system 1 in order to eliminate the need to carry out an emergency stop for the fuel cell system 1 in case of a so-called “load shedding,” i.e., in case of an abrupt switch-off of major electric consumers 54.

Provisions may be made in another embodiment for the heat-insulating covers 16, 42 and 32 to be coupled with one another and/or to be attached to one another. The goal of this is to maintain the most uniform temperature level possible in the said covers 16, 32, 42 or in the corresponding modules 15, 31 and 41.

In addition, FIGS. 1 through 3 indicate a box 39, in which the entire fuel cell system 1 is accommodated. This box 39 may form a common housing for the components of the system 1, which simplifies the mounting of the system in the mobile or stationary application in question. For example, system 1 may be integrated in this box 39 in a vehicle or fastened to a carrier or to a wall or to a base in case of a stationary application.

The valves 46, 49, 51, 70, 74, 76 used may be designed as on-off valves or control valves or even as control valves.

The start-up procedure of the fuel cell system 1 can be summed up as follows: The auxiliary burner 20 is used during a cold start of the fuel cell system 1 to preheat the fuel cell air, and preheating is carried out at the same time via the recirculation corresponding to the recirculation circuit 68 by circulating residual gas between the anode side 6 and the reformer 33.

Since the residual gas being delivered in the circulation circuit 68 may contain air or oxygen gas, a first anode limit temperature, which may be, for example, 250° C. but is at any rate below a reoxidation temperature of the particular anode material used, is monitored. This reoxidation temperature may be, for example, about 300° C. If the first anode limit temperature, i.e., about 250° C., is now reached, reformer 33 is put into operation. Depending on the current catalyst temperature, two start-up procedures are available for this, namely, a warm start in case of a sufficiently high catalyst temperature as well as cold start in case of an insufficient catalyst temperature. The catalyst limit temperature to be borne in mind in this connection may be, for example, about 350° C.

If a cold start is necessary for the reformer 33, reformer air and fuel are fed at a superstoichiometric ratio, ignited, and reacted, while an oxygen-containing reformer waste gas is formed, which rapidly brings the catalyst 40 to a minimum operating temperature, which makes it possible to change over to the reformer operating state. As was described, this reformer waste gas can be sent through the anode side 6, because it is only a comparatively small volume flow. As an alternative, if a bypass line 69 is present for this case, the anode side 6 may be bypassed in order to prevent the electrolyte 10 from coming into contact with oxygen on the anode side.

As soon as the catalyst 40 has reached the desired catalyst limit temperature, it is possible to change over from the burner operating state to the reformer operating state. Reformer air and fuel are fed at a substoichiometric ratio to the reformer 33 in the reformer operating state, as a result of which desired reformate gas can be generated, preferably by means of partial oxidation. If there is a sufficiently high catalyst temperature already from the very beginning, the reformer 33 can be started hot, i.e., it can be immediately operated in the reformer operating state.

Oxygen that may be contained in residual gases can be reacted during the reformer operating state in conjunction with the continued maintenance of the recirculation of residual gases until no more oxygen is recirculated. The risk of damage to the anode due to contact with oxygen is now eliminated.

Two different possibilities are now available for the further mode of operation of the fuel cell system 1 or for the further course of the start-up procedure. On the one hand, reformer 33 can continue to be operated in the reformer operating state in order to achieve the desired heating of the fuel cell 2 as soon as possible. However, there is a risk of soot deposition on the anode side at the electrolyte 10 because of the still comparatively low temperature at the electrolyte 10. As an alternative, the reformer 33 may, on the other hand, be temporarily switched off again in order to bring about the further heating of the fuel cell 2 exclusively by the auxiliary burner 20. The recirculation of residual gas between the anode side 6 and the reformer 33 can be continued during this time. Since only oxygen-free residual gas is circulated now, there is no risk for the anode. At the same time, the high temperature level can be maintained in the reformer 33 during this operation in order to make possible a warm start of the reformer 33 at a later point in time.

For example, reformer 33 can again be switched off when another or third predetermined anode limit temperature is reached. This third anode limit temperature may be, e.g., about 350° C. or about 400° C. It is advantageously selected to be so high that an oxygen-free residual gas is ensured. As an alternative, the point in time at which reformer 33 is to be switched off can also be determined by means of a lambda probe, which measures the oxygen content in the residual gas.

As soon as sufficient heating of the fuel cell 2 has then been achieved, a fourth anode limit temperature can be reached, which may be, for example, about 650° C. When this fourth anode limit temperature is reached, reformer 33 can again be switched on, in which case a warm start is possible. This is of increased interest because no air excess and hence no oxygen excess develops in the gas arriving from the reformer 33 during the warm start.

As soon as the fuel cell 2 reaches its operating temperature or as soon as the anode of the fuel cell reaches its anode operating temperature, fuel cell 2 can be put into operation to release current. This anode operating temperature also forms at the same time a second anode limit temperature, and the auxiliary burner 20 is switched off when this anode limit temperature is present. The anode operating temperature may advantageously also be about 650° C., so that the second anode limit temperature, the fourth anode limit temperature and the anode operating temperature may be ultimately equal.

It is also possible for the start-up of the fuel cell system 1 in an entirely alternative embodiment to use only the auxiliary burner 20 to preheat the fuel cell air from the very beginning in order to reach the anode operating temperature in this manner. Residual gas is not circulated in this alternative procedure between the anode side 6 and the reformer 33. When the anode operating temperature is reached, reformer 33 is then put into operation. Since it is comparatively cold in the absence of recirculation, cold start must be performed, so that the reformer 33 can be operated at first as a burner and as a reformer only thereafter. A short-term contacting of the hot anode with oxygen is accepted in this procedure, which is temporarily tolerable for certain electrolytes 10. The advantage of this embodiment is that the risk of soot deposition at the electrolyte 10 is greatly reduced, because the temperature range critical for this has already been exceeded.

While specific embodiments of the invention have been described in detail to illustrate the application of the principles of the invention, it will be understood that the invention may be embodied otherwise without departing from such principles.

What is claimed is:

1. A process for starting up a fuel cell system, the process comprising:
providing a fuel cell system having a fuel cell with a cathode side and an anode side, a reformer and an auxiliary burner;
preheating fuel cell air with the auxiliary burner;
feeding the preheated fuel cell air to the cathode side of the fuel cell;
circulating residual gas from the anode side of the fuel cell to the reformer and from the reformer to the anode side of the fuel cell.

2. A process in accordance with claim 1, wherein when a predetermined first anode limit temperature is reached, the reformer is operated at least temporarily in a reformer operating state in order to react oxygen possibly contained in the residual gas, which continues to circulate between the anode side and the reformer.

3. A process in accordance with claim 2, wherein;
the reformer is operated in a burner operating state below a predetermined catalyst limit temperature of a catalyst of the reformer; and
the operation of the reformer is changed over to the reformer operating state when the catalyst limit temperature is reached.

4. A process in accordance with claim 2, further comprising the step of providing a waste gas line wherein:
gas arriving from the reformer reaches the waste gas line while bypassing the anode side of the fuel cell; or
gas arriving from the reformer reaches the waste gas line through the anode side;
and wherein gas arriving from the reformer may preheat fuel cell air regardless of whether the gas arriving from the reformer flows through or bypasses the anode side.

5. A process in accordance with claim 2, further comprising the step of providing a residual gas burner wherein:
the reformer generates reformate gas in the reformer operating state;
said reformate gas is reacted in the residual gas burner together with the fuel cell air removed from the cathode side to produce burner waste gas; and
the fuel cell air may be preheated with the burner waste gas formed in the residual gas burner.

6. A process in accordance with claim 5, wherein the auxiliary burner is deactivated as soon as the residual gas burner takes over the preheating of the fuel cell air or as soon as another second predetermined anode limit temperature or anode operating temperature is reached.

7. A process in accordance with claim 5, further comprising the step of providing a heat exchanger for heat transfer between the burner waste gas and the fuel cell air wherein:
the residual gas burner is operated such that the burner waste gas does not exceed a heat exchanger limit temperature of the heat exchanger for heat transfer between the burner waste gas and the fuel cell air.

8. A process in accordance with claim 5, wherein the reformer is switched off again when another third predetermined anode limit temperature is reached and the oxygen-free residual gas is again circulated between the anode side and the reformer.

9. A process in accordance with claim 8, wherein the reformer is switched on again when another fourth predetermined anode limit temperature is reached and is operated immediately in the reformer operating state.

10. A process in accordance with claim 2, wherein the fuel cell is activated when another second predetermined anode limit temperature or anode operating temperature is reached.

11. A process in accordance with claim 1, further comprising the steps of:
providing a fuel cell air line;
providing a first heat exchanger arranged in the fuel cell air line;
providing a bypass air line, which bypasses the first heat exchanger;
providing a second heat exchanger arranged in the bypass air line;
regulating a temperature of the fuel cell by introducing air into the fuel cell air line downstream of the heat exchanger from the bypass air line, which bypasses the heat exchanger arranged in a fuel cell air line or via the bypass line which bypasses the second heat exchanger arranged in the bypass air line.
